(19) United States
(12) Patent Application Publication
(10) Pub. No.: US 2025/0217994 A1
(43) Pub. Date: Jul. 3, 2025

(54) 3D Shape Part Segmentation by Vision-Language Model Distillation

(71) Applicant: MEDIATEK INC., Hsinchu City (TW)

(72) Inventors: Ardian Umam, Hsinchu City (TW); Cheng-Kun Yang, Hsinchu City (TW); Yen-Yu Lin, Hsinchu City (TW)

(73) Assignee: MEDIATEK INC., Hsinchu City (TW)

(21) Appl. No.: 19/004,417

(22) Filed: Dec. 29, 2024

Related U.S. Application Data
(60) Provisional application No. 63/615,818, filed on Dec. 29, 2023.

(51) Int. Cl. G06T 7/11; G06T 15/00

(52) U.S. Cl. CPC G06T 7/11; G06T 15/005

(57) ABSTRACT

A method for three-dimensional (3D) shape part segmentation includes obtaining two-dimensional (2D) predictions for part segmentation of a 3D shape, lifting the 2D predictions onto the 3D shape to obtain initial 3D part segmentation knowledge, processing the 3D shape using a 3D encoder to extract geometric features, performing a distillation process to refine the initial 3D part segmentation knowledge, and generating a final 3D shape part segmentation according to the refined 3D part segmentation knowledge and the geometric features.

### CROSS REFERENCE TO RELATED APPLICATIONS

This application claims the benefit of U.S. Provisional Application No. 63/615,818, filed on Dec. 29, 2023. The content of the application is incorporated herein by reference.

### BACKGROUND

3D shape part segmentation is a fundamental task in computer vision and graphics, with applications ranging from shape editing and stylization to augmented reality and robotics. Traditionally, this task has relied heavily on large datasets with manual part annotations, which are time-consuming and expensive to create. This limitation has spurred interest in developing methods that can perform well with limited or no labeled 3D data.

Recent advances in vision-language models (VLMs) have shown remarkable zero-shot capabilities in various 2D vision tasks. These models, trained on vast amounts of image-text pairs, can generalize to recognize and segment objects not seen during training. This success has led researchers to explore ways of leveraging VLMs for 3D tasks, including shape part segmentation.

Previous attempts to use VLMs for 3D shape part segmentation have primarily focused on projecting 3D shapes into multiple 2D views and then directly transferring the VLM 2D predictions back to the 3D space. Notable examples include PointCLIP, PointCLIPv2, PartSLIP, and SATR. While these methods have shown promise, they face several challenges. Some 3D regions may lack corresponding 2D predictions due to occlusion or being outside detected bounding boxes. Additionally, 2D predictions from different views may be inconsistent, leading to errors when transferred to 3D. Direct transfer of 2D predictions doesn't fully exploit the geometric information present in 3D shapes, and existing methods typically process each 3D shape independently, missing opportunities to learn from patterns across multiple shapes.

These limitations highlight the need for a more sophisticated approach that can better bridge the gap between 2D VLM knowledge and 3D shape understanding. Additionally, the rapid progress in 3D shape generation models presents an opportunity to leverage synthetic data to enhance learning, particularly in scenarios with limited real-world 3D data. The current invention addresses these challenges by introducing a new cross-modal distillation framework.

### SUMMARY

An embodiment provides a method for three-dimensional (3D) shape part segmentation performed by a processor. The method comprises obtaining two-dimensional (2D) predictions for part segmentation of a 3D shape, lifting the 2D predictions onto the 3D shape to obtain initial 3D part segmentation knowledge, processing the 3D shape using a 3D encoder to extract geometric features, performing a distillation process to refine the initial 3D part segmentation knowledge, and generating a final 3D shape part segmentation according to the refined 3D part segmentation knowledge and the geometric features.

An embodiment provides an apparatus for three-dimensional (3D) shape part segmentation, comprising a memory and a processor coupled to the memory. The memory is used to store instructions and 3D shape data. The processor is used to execute the instructions to obtain two-dimensional (2D) predictions for part segmentation of a 3D shape, lift the 2D predictions onto the 3D shape to obtain initial 3D part segmentation knowledge, process the 3D shape using a 3D encoder to extract geometric features, perform a distillation process to refine the initial 3D part segmentation knowledge, and generate a final 3D shape part segmentation according to the refined 3D part segmentation knowledge and the geometric features.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 presents an embodiment of a distillation method that carries out zero-shot 3D shape part segmentation with a 2D vision-language model according to the embodiments.

FIG. 2a presents an embodiment of a pipeline where the knowledge extracted from a VLM is distilled to carry out 3D shape part segmentation by teaching a 3D student network.

FIG. 2b illustrates knowledge extraction by back-projection when bounding-box VLM (B-VLM) is adopted.

FIG. 2c illustrates knowledge extraction by back-projection when pixel-wise VLM (P-VLM) is adopted.

FIG. 3 presents the confidence scores before C and after C_{bd} performing backward distillation.

FIG. 4 presents visualization of the zero-shot segmentation results on the ShapeNetPart dataset.

FIG. 5 presents ablation study on number of views and various shape types for 2D multiview rendering on the ShapeNetPart dataset.

FIG. 6 depicts a flow diagram of an embodiment of the method for 3D shape part segmentation.

FIG. 7 depicts a simplified block diagram of an embodiment of an apparatus for performing the method for 3D shape part segmentation.

### DETAILED DESCRIPTION

### 1. Related Works

3D shape part segmentation is essential to various 3D vision applications, such as shape editing, stylization, and augmentation. Despite its significance, acquiring part annotations for 3D data, such as point clouds or mesh shapes, is labor-intensive and time-consuming.

Zero-shot learning generalizes a model to unseen categories without annotations and has been notably uplifted by recent advances in vision-language models (VLMs). By learning on large-scale image text data pairs, VLMs show promising generalization abilities on various 2D recognition tasks. Recent research efforts have been made to utilize VLMs for zero-shot 3D part segmentation, where a 3D shape is projected into multi-view 2D images, and a VLM is applied to these images for 2D prediction acquisition. Specifically, PointCLIP and PointCLIPv2 produce 3D pointwise semantic segmentation by averaging their corresponding 2D pixel-wise predictions. Meanwhile, PartSLIP and SATR present a designated weighting mechanism to aggregate multi-view bounding box predictions.

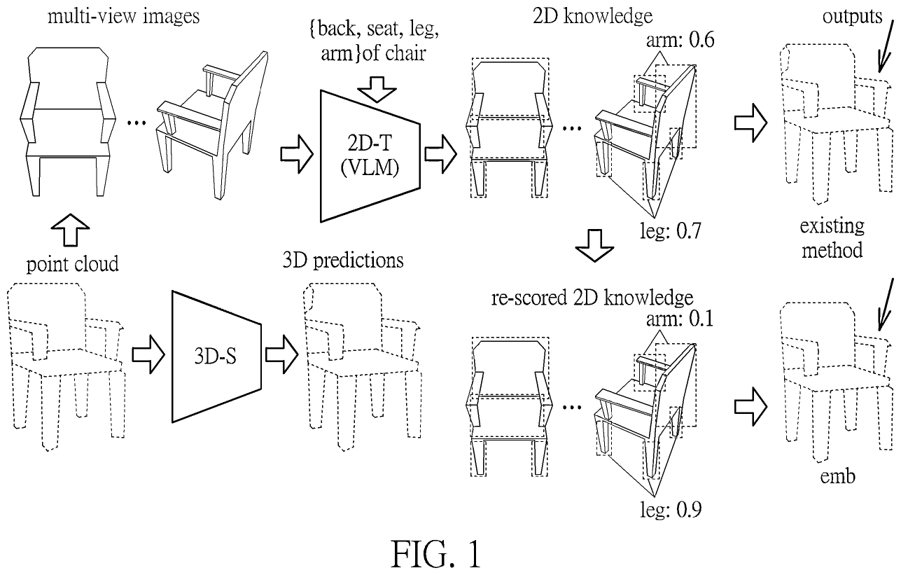

The key step of zero-shot 3D part segmentation with 2D VLMs, e.g., lies in the transfer from 2D pixel-wise or bounding-box-wise predictions to 3D point segmentation. This step is challenging due to three major issues. First (I₁), some 3D regions lack corresponding 2D predictions in multi-view images, which are caused by occlusion or not being covered by any bounding boxes, illustrated with black and gray points, respectively, in FIG. 1. This issue is considered a limitation in the previous work. Second (I₂), there exists potential inconsistency among 2D predictions in multi-view images caused by inaccurate VLM predictions. Third (I₃), existing work directly transfers 2D predictions to segmentation of a single 3D shape. The 2D predictions yielded based on appearance features are not optimal for 3D geometric shape segmentation, while geometric evidence given across different 3D shapes is not explored.

To alleviate the three issues I₁-I₃, unlike existing methods directly transferring 2D predictions to 3D segmentation, propose a cross-modal distillation framework with a teacher-student model is proposed. Specifically, a VLM is utilized as a 2D teacher network, accepting multiview images of a single 3D shape. The VLM is pre-trained on large-scale image-text pairs and can exploit appearance features to make 2D predictions. The student network is developed based on a point cloud backbone. It is derived from multiple, unlabeled 3D shapes and can extract point-specific geometric features. The proposed distillation method, Part-Distill, leverages the strengths of both networks, hence improving zero-shot 3D part segmentation. The student network learns from not only the 2D teacher network but also 3D shapes. It can extract point-wise features and segment 3D regions uncovered by 2D predictions, hence tackling issue I₁. As a distillation-based method, PartDistill tolerates inconsistent predictions between the teacher and student networks, which alleviates issue I₂ of negative transfer caused by wrong VLM predictions.

The student network considers both appearance and geometric features. Thus, it can better predict 3D geometric data and mitigate issue I₃. As shown in FIG. 1, the student network can correctly predict the undetected arm of the chair (see the black arrows) by learning from other chairs.

PartDistill carries out a bi-directional distillation. It first forward distills the 2D knowledge to the student network. It is observed that after the student integrates the 2D knowledge, both teacher and student knowledge can be jointly referred to perform backward distillation which re-scores the 2D knowledge based on its quality. Those of low quality will be suppressed with lower scores, such as from 0.6 to 0.1 for the falsely detected arm box in FIG. 1, and vice versa. Finally, this re-scored knowledge is utilized by the student network to seek better 3D segmentation.

The main contributions of this work are summarized as follows. First, PartDistill is introduced, a cross-modal distillation framework that transfers 2D knowledge from VLMs to facilitate 3D part segmentation. PartDistill addresses three identified issues present in existing methods and generalizes to both VLM with bounding-box predictions (B-VLM) and pixel-wise predictions (P-VLM). Second, a bi-directional distillation is proposed, which involves enhancing the quality of 2D knowledge and subsequently improving the 3D predictions. Third, PartDistill can leverage existing generative models to enrich knowledge sources for distillation. Extensive experiments demonstrate that PartDistill surpasses existing methods by substantial margins on widely used benchmark datasets, ShapeNet-Part and PartE, with more than 15% and 12% higher mIoU scores, respectively. PartDistill consistently outperforms competing methods in zero-shot and few-shot scenarios on 3D data in point clouds or mesh shapes.

### 2. Further Related Work

Vision-language models: Based on learning granularity, vision-language models (VLMs) can be grouped into three categories, including the image-level, pixel-level, and object-level categories. The second and the third categories make pixel-level and bounding box predictions, respectively, while the first category produces image-level predictions. Recent research efforts on VLMs have been made for cross-level predictions. For example, pixel-level predictions can be inferred from an image-level VLM via up-sampling the 2D features into the image dimensions, as shown in PointCLIPv2. This work proposes a cross-modal distillation framework that learns and transfers knowledge from a VLM in the 2D domain to 3D shape part segmentation.

3D part segmentation using vision-language models: State-of-the-art zero-shot 3D part segmentation is developed by utilizing a VLM and transferring its knowledge in the 2D domain to the 3D space. The pioneering work PointCLIP utilizes CLIP. PointCLIPv2 extends PointCLIP by making the projected multi-view images more realistic and proposing LLM-assisted text prompts, hence producing more reliable CLIP outputs for 3D part segmentation.

Both PointCLIP and PointCLIPv2 rely on individual pixel predictions in 2D views to get the predictions of the corresponding 3D points, but individual pixel predictions are less unreliable. PartSLIP suggests to extract superpoints from the input point cloud. Therefore, 3D segmentation is estimated for each superpoint by referring to a set of relevant pixels in 2D views. PartSLIP uses GLIP to output bounding boxes and further proposes a weighting mechanism to aggregate multi-view bounding box predictions to yield 3D superpoint predictions. SATR shares a similar idea with PartSLIP but handles 3D mesh shapes instead of point clouds.

Existing methods directly transfer VLM predictions from 2D images into 3D spaces and pose three issues: (I₁) uncovered 3D points, (I₂) negative transfer, and (I₃) cross-modality predictions, as discussed before. A distillation-based method is presented to address all three issues and make substantial performance improvements.

2D to 3D distillation: Seminal work of knowledge distillation aims at transferring knowledge from a large model to a small one. Subsequent research efforts adopt this idea of transferring knowledge from a 2D model for 3D understanding. However, these methods require further fine-tuning with labeled data. Open-Scene and CLIP2Scene require no fine-tuning and share a similar concept with the method of distilling VLMs for 3D understanding, with disclosed method designed for part segmentation and conventional method for indoor/outdoor scene segmentation. The major difference is that the method can enhance the knowledge sources in the 2D modality via the proposed backward distillation. Moreover, the method is generalizable to both P-VLM (pixel-wise VLM) and B-VLM (bounding-box VLM), while their methods are only applicable to P-VLM.

### 3. Proposed Method

### 3.1. Overview

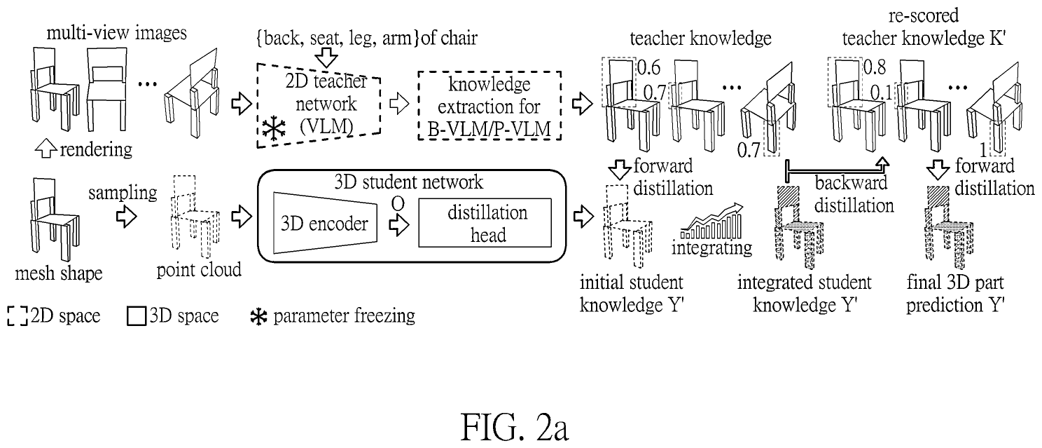

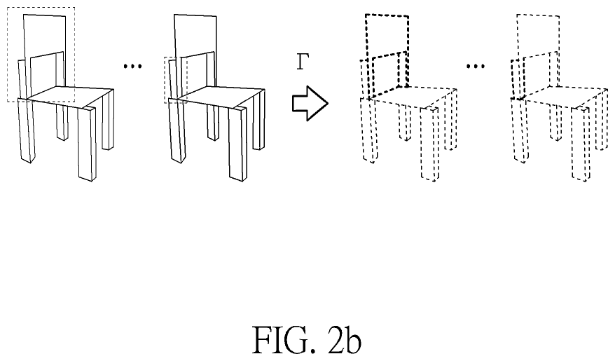

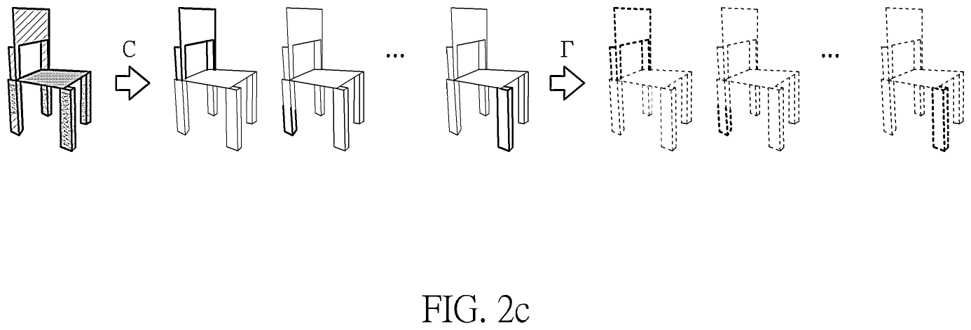

Given a set of 3D shapes, this work aims to segment each one into R semantic parts without training with any part annotations. To this end, a cross-modal bi-directional distillation framework, PartDistill, is proposed, which transfers 2D knowledge from a VLM to facilitate 3D shape part segmentation. As illustrated in FIG. 2, the framework takes triplet data as input, including the point cloud of the shape with N 3D points, multi-view rendered images from the shape in V different poses, and R text prompts with each describing the target semantic parts within the 3D shapes.

For the 2D modality, the V multi-view images and the text prompts are fed into a Bounding-box VLM (B-VLM) or Pixel-wise VLM (P-VLM). For each view v, a B-VLM produces a set of bounding boxes, B^{v}={bⁱ}ᵢ₌₁^{β} while a P-VLM generates pixel-wise predictions S^{v}. Knowledge extraction (Sec 3.2) for each B^{v} or S^{v} is then performed; Namely, the 2D predictions are transferred (or called lifted) into the 3D space through back-projection for a B-VLM or connected-component labeling followed by back-projection for a P-VLM, as shown in FIG. 2b and FIG. 2c, respectively. Subsequently, a set of D teacher knowledge units [symbol] ={k}_{d=1}^{D}=Y^{d}, M_{d=1}^{D}, is obtained by aggregating from all V multi-view images. Each unit d comprises point-wise part probabilities, Y^{d}∈ [symbol] ^{N×R} from the teacher VLM network, accompanied with a mask, M^{d}∈{0, 1}^{N}, identifying the points included in this knowledge unit.

For the 3D modality, the point cloud is passed into the 3D student network with a 3D encoder and a distillation head, producing point-wise part predictions, \tilde{Y}∈ [symbol] ^{N×R}. With the proposed bi-directional distillation framework, distill teacher's 2D knowledge is forwarded by aligning \tilde{Y} with [symbol] via minimizing the proposed loss, [symbol] , specified in Sec 3.2. The 3D student network integrates 2D knowledge from the teacher through optimization. The integrated student knowledge \tilde{Y}′ and the teacher knowledge [symbol] are then jointly referred to perform backward distillation from 3D to 2D, detailed in Sec. 3.3, which re-scores each knowledge unit k^{d} based on its qualities, as shown in FIG. 2a-2c. Finally, the re-scored knowledge [symbol] ′ is used to refine the student knowledge to get final part segmentation predictions \tilde{Y}_{f} by assigning each point to the part with the highest probability.

### 3.2. Forward Distillation: 2D to 3D

The method extracts the teacher's knowledge in the 2D modality and distills it in the 3D space. In the 2D modality, V multi-view images {I^{v}∈ [symbol] ^{H×W}}ᵥ₌₁^{V} are rendered from the 3D shape. These V multi-view images together with the text prompts T of R parts are passed to the VLM to get the knowledge in 2D spaces. For a B-VLM, a set of β bounding boxes, B^{v}={bⁱ}ᵢ₌₁^{β}, is obtained from the v-th image, with bⁱ∈ [symbol] ^{4+R} encoding the box coordinates and the probabilities of the R parts. For a P-VLM, a pixel-wise prediction map S^{v}∈ [symbol] ^{H×W×R} is acquired from the v-th image. Knowledge extraction is applied to each B^{v} and each S^{v} to obtain a readily distillable knowledge [symbol] in the 3D space, as illustrated in FIG. 2b and FIG. 2c, respectively.

For a B-VLM, bounding boxes can directly be treated as the teacher knowledge. For a P-VLM, knowledge extraction starts by applying connected-component labeling to S^{v} to get a set of ρ segmentation components, {sⁱ∈ [symbol] ^{H×W×R}}ᵢ₌₁^{ρ}, indicating if the r-th part is with the highest probability in each pixel. The process of applying a VLM to a rendered image and the part text prompts can be summarized as:

$$VLM ( {I}^{v} , T ) = \{ \begin{matrix}{B}^{v} = {\{ {b}^{i} \}}_{i = 1}^{β} & for B - VLM \\ ℂ ( {S}^{v} ) = {\{ {s}^{i} \}}_{i = 1}^{ρ} & for P - VLM\end{matrix} \qquad Eq ( 1 )$$

where [symbol] denotes connected-component labeling.

Each box bⁱ or each prediction map sⁱ is then back-project to the 3D space, i.e.,

$${k}^{i} = ( {Y}^{i} , {M}^{i} ) = \{ \begin{matrix}Γ ( {b}^{i} ) & for B - VLM \\ Γ ( {s}^{i} ) & for P - VLM\end{matrix} \qquad Eq ( 2 )$$

where Γ denotes the back-projection operation with the camera parameters used for multi-view image rendering, Yⁱ∈ [symbol] ^{N×R} is the point-specific part probabilities, and Mⁱ∈{0,1}^{N} is the mask indicating which 3D points are covered by bⁱ or sⁱ in the 2D space. The pair (Yᵢ, Mᵢ) yields a knowledge unit, kⁱ, upon which the knowledge rescoring is performed in the backward distillation.

For the 3D modality, a 3D encoder, e.g., Point-M2AE, is applied to the point cloud and obtains perpoint features, O∈ [symbol] ^{N×E}, capturing local and global geometrical information. Then point-wise part prediction, \tilde{Y}∈ [symbol] ^{N×R}, is estimated by feeding the point features O into the distillation head. The cross-modal distillation is performed by teaching the student network to align the part probability from the 3D modality \tilde{Y} to their 2D counterparts Y via minimizing the designated distillation loss.

Distillation loss. Via Eq. 1 and Eq. 2, assuming that D knowledge units, [symbol] ={k^{d}}_{d=1}^{D}={Y^{d}, M^{d}}_{d=1}^{D}, are obtained from the multi-view images. The knowledge [symbol] exploits 2D appearance features and is incomplete as several 3D points are not covered by any 2D predictions, i.e., issue I₁. To distill this incomplete knowledge, a masked cross-entropy loss is defined as:

$$= - {\sum }_{d = 1}^{D} \frac{1}{\vert {M}^{d} \vert} {\sum }_{n = 1}^{N} {\sum }_{r = 1}^{R} {M}_{n}^{d} {C}_{n}^{d} {Z}_{n , r}^{d} log ( {\tilde{Y}}_{n , r} ) \qquad Eq ( 3 )$$

where

$${C}_{n}^{d} = {max}_{r} ( {Y}_{n}^{d} ( r ) )$$

is the confidence score of k^{d} on point n. Z_{n,r}^{d} takes value 1 if part r receives the highest probability on k^{d}, and 0 otherwise. |M^{d}| is the area covered by the mask M^{d}.

By minimizing Eq. 3, the student network is taught to align its prediction \tilde{Y} to the distilled prediction Y by considering the points covered by the mask and using the confidence scores as weights. Despite learning from incomplete knowledge, the student network extracts point features that capture geometrical information of the shape, thus enabling it to reasonably segment the points that are not covered by 2D predictions, hence addressing issue I₁. This can be regarded as interpolating the learned part probability in the feature spaces by the distillation head.

As a distillation-based method, the method allows partial inconsistency among the extracted knowledge {k^{d}}_{d=1}^{D} caused by inaccurate VLM predictions, thereby alleviating issue I2 of negative transfer. In the method, the teacher network works on 2D appearance features, while the student network extracts 3D geometric features. After distillation via Eq. 3, the student network can exploit both appearance and geometric features from multiple shapes, hence mitigating issue I₃ of cross-modal transfer. It is worth noting that unlike the conventional teacher-student models which solely establish a one-to-one correspondence, each knowledge unit k^{d} is further rescored based on its quality (Sec. 3.3), and improve distillation by suppressing low-quality knowledge units.

### 3.3. Backward Distillation: 3D to 2D

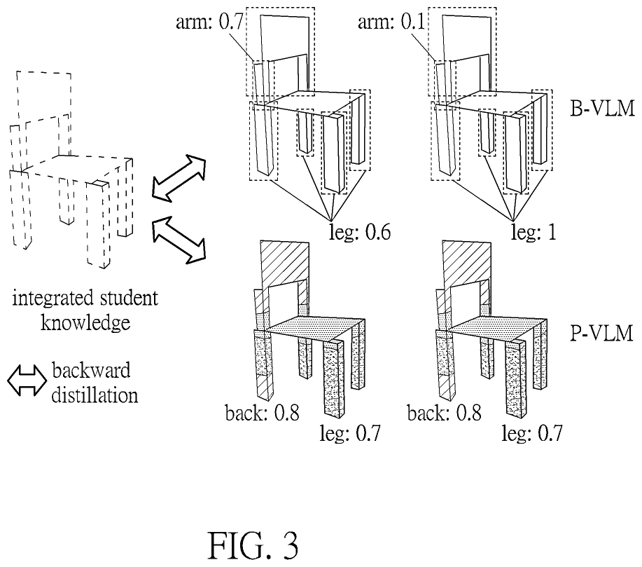

In Eq. 3, all knowledge units {k^{d}}_{d=1}^{D}, are considered weighted by their confidence scores. However, due to the potential VLM mispredictions, not all knowledge units are reliable. Hence, the knowledge units are refined by assigning higher scores to those of high quality and suppressing the low-quality ones. It is observed that once the student network has thoroughly integrated the knowledge from the teacher, both teacher and integrated student knowledge \tilde{Y}′ can be jointly referred to achieve the goal, by re-scoring the confidence score C^{d} to Cₖᵣ^{d} as:

$${C}_{bd}^{d} = \frac{\vert {M}^{d} ( arg max ( {Y}^{d} ) ⇔ arg max ( {\tilde{Y}}^{′} ) ) \vert}{\vert {M}^{d} \vert} \qquad Eq ( 4 )$$

where ⇔ denotes logical equality. In this way, each knowledge unit k^{d} is re-scored: Those with high consensus between teacher [symbol] and integrated student knowledge \tilde{Y}′ have higher scores, such as those on the chair legs shown in FIG. 3, and those with low consensus are suppressed by the reduced scores, such as those on the chair arm (B-VLM) and back (P-VLM) in FIG. 3. Note that for simplicity, only two scores are displayed in each shape of FIG. 3 and the average pixel-wise scores are shown in P-VLM. Afterward, the student network continues to learn with the re-scored knowledge [symbol] ′ by minimizing the loss in Eq. 3 with C being replaced by Cₖᵣ, and produces the final part segmentation predictions \tilde{Y}_{f}. To justify that the student network has thoroughly integrated the knowledge from the teacher, the moving average of the loss value is tracked for every epoch, and it is determined whether the value in a subsequent epoch is lower than a specified threshold τ.

### 3.4. Test-Time Alignment

In general, the method performs the alignment via Eq. 3 with a collection of shapes before the student network is utilized to carry the 3D shape part segmentation. If such a pre-alignment is not preferred, a special case of the method is provided, test-time alignment (TTA), where the alignment is performed for every single shape in test time. To maintain the practicability, TTA needs to achieve a near instantaneous completion. To that end, TTA employs a readily used 3D encoder, e.g., pre-trained Point M2AE, freczes its weights, and only updates the learnable parameters in the distillation head, which significantly fastens the TTA completion.

### 3.5. Implementation Details

The proposed framework is implemented in PyTorch and is optimized for 50 epochs via Adam optimizer with a learning rate and batch size of 0.001 and 16, respectively. Unless further specified, the student network employs PointM2AE pre-trained on the ShapeNet55 dataset as the 3D extractor, freezes its weights, and only updates the learnable parameters in the distillation head. A multi-layer perceptron consisting of 4 layers, with ReLU activation, is adopted for the distillation head. To fairly compare with the competing methods, their respective settings are followed, including the used text prompts and the 2D rendering. Their methods render each shape into 10 multi-view images, either from a sparse point cloud, a dense point cloud, or a mesh shape. For the point cloud input, 2048 points are uniformly sampled for each shape. Lastly, class-balance weighting is applied during the alignment and specify threshold τ=0.01 in the backward distillation.

### 4. Experiments

### 4.1. Dataset and Evaluation Metric

The effectiveness of the method are evaluated on two main benchmark datasets, ShapeNetPart and PartE. While ShapeNetPart dataset contains 16 categories with a total of 31,963 shapes, PartE contains 2,266 shapes, covering 45 categories. The mean intersection over union (mIoU) is adopted to evaluate the segmentation results on the test-set data, measured against the ground truth label. The mIoU is first calculated for each part category across all shapes in the test-set data. Then, for each object category, the average of the part mIoU is computed.

### 4.2. Zero-Shot Segmentation

To compare with the competing methods, each of their settings is adopted and their mIoU performances are reported from their respective papers. Specifically, for PVLM, the approach of PointCLIP and PointCLIPv2 is followed to utilize CLIP with ViT-B/32 backbone, and their pipeline is used to obtain the pixel-wise predictions from CLIP. For B-VLM, a GLIP-Large model is employed in the method to compare with PartSLIP and SATR which also use the same model. While most competing method competing methods report their performances on the ShapeNetPart dataset, PartSLIP evaluates its method on the PartE dataset.

TABLE 1
Zero-shot segmentation on the ShapeNetPart dataset, reported in mIoU (%).

| | Data | | | | | | | | | | | | |
|---|---|---|---|---|---|---|---|---|---|---|---|---|---|
| VLM | type | Method | Airplane | Bag | Cap | Chair | Earphone | Guitar | Knife | Laptop | Mug | Table | Overall |
| CLIP | Point | Point- | 22.0 | 44.8 | 13.4 | 18.7 | 28.3 | 22.7 | 24.8 | 22.9 | 48.6 | 45.4 | 31.0 |
| | cloud | CLIP | | | | | | | | | | | |
| | | Point- | 35.7 | 53.3 | 53.1 | 51.9 | 48.1 | 59.1 | 66.7 | 61.8 | 45.5 | 49.8 | 48.4 |
| | | CLIPv2 | | | | | | | | | | | |
| | | Emb. | 37.5 | 62.6 | 55.5 | 56.4 | 55.6 | 71.7 | 76.9 | 67.4 | 53.5 | 62.9 | 53.8 |
| | | (Pre) | | | | | | | | | | | |
| | | Emb. | 40.6 | 75.6 | 67.2 | 65.0 | 66.3 | 85.8 | 79.8 | 92.6 | 83.1 | 68.7 | 63.9 |
| | | (TTA) | | | | | | | | | | | |
| GLIP | Point | Emb. | 57.3 | 62.7 | 56.2 | 74.2 | 45.8 | 60.6 | 78.5 | 85.7 | 82.5 | 62.9 | 53.8 |
| | cloud | (TTA) | | | | | | | | | | | |
| | | Emb. | 69.3 | 70.1 | 67.9 | 86.5 | 51.2 | 76.8 | 85.7 | 91.9 | 85.6 | 79.6 | 54.7 |
| | | (Pre) | | | | | | | | | | | |
| | mesh | SATR | 32.2 | 32.1 | 21.8 | 25.2 | 19.4 | 37.7 | 40.1 | 50.4 | 76.4 | 22.4 | 32.3 |
| | | Emb. | 53.2 | 61.8 | 44.9 | 66.4 | 43.0 | 50.7 | 66.3 | 68.3 | 83.9 | 58.8 | 32.3 |
| | | (TTA) | | | | | | | | | | | |
| | | Emb. | 64.8 | 64.4 | 51.0 | 67.4 | 48.3 | 64.8 | 70.0 | 83.1 | 86.5 | 79.3 | 49.5 |
| | | (Pre) | | | | | | | | | | | |

TABLE 2
Zero-shot segmentation on the PartE dataset, reported in mIoU (%).

| | Data | | | | | | | | | | | | |
|---|---|---|---|---|---|---|---|---|---|---|---|---|---|
| VLM | type | Method | Bottle | Cart | Chair | Display | Kettle | Knife | Lamp | Oven | Suitcase | Table | Overall |
| GLIP | Point | Part- | 76.3 | 87.7 | 60.7 | 43.8 | 20.8 | 46.8 | 37.1 | 33.0 | 40.2 | 47.7 | 27.3 |
| | cloud | SLIP | | | | | | | | | | | |
| | | Emb. | 77.4 | 88.5 | 74.1 | 50.5 | 24.2 | 59.2 | 58.8 | 34.2 | 43.2 | 50.2 | 39.9 |
| | | (TTA) | | | | | | | | | | | |

Accordingly, the comparison is carried out separately to ensure fairness, based on the employed VLM model and the shape data type, i.e., point cloud or mesh data, as shown in Tables 1 and 2. In Table 1, two versions of the method are provided, including test-time alignment (TTA) and pre-alignment (Pre) with a collection of shapes, from the train-set data. It is noted that in the pre-alignment version, the method does not use any labels, i.e., only unlabeled shape data are utilized.

First, the method is compared to PointCLIP and PointCLIPv2 (both utilize CLIP as the P-VLM) on the zero-shot segmentation for the ShapeNetPart dataset, as can be seen in the first part of Table 1. It is evident that the method for both TTA and pre-alignment versions achieves substantial improvements in all categories. For the overall mIoU, calculated by averaging the mIoUs from all categories, the method attains 5.4% and 15.5% higher mIoU for TTA and pre-alignment versions, respectively, compared to the best mIoU from the other methods. Such results reveal that the method which simultaneously exploits appearance features on the teacher network and geometric features on the student network can better aggregate the 2D predictions for 3D part segmentation than directly averaging the corresponding 2D predictions as in the competing methods, where geometric evidence is not explored.

Next, as shown in the last three rows of Table 1, the method is compared to SATR that works on mesh data shapes. To obtain the mesh face predictions, the point predictions are propagated via a nearest neighbor's approach, where each face is voted from its five nearest points.

The method achieves 17.2% and 24% higher overall mIoU than SATR for TTA and pre-alignment versions, respectively. Then, the method is compared with PartSLIP in Table 2 wherein only results from TTA are provided since the PartE dataset does not provide train-set data. One can sec that the method consistently obtains better segmentations, with 12.6% higher overall mIoU than PartSLIP.

In PartSLIP and SATR, as GLIP is utilized, the uncovered 3D regions (issue I₁) could be intensified by possible undetected areas, and the negative transfer (issue I₂) may also be escalated due to semantic leaking, where the box predictions cover pixels from other semantics. On the other hand, the method can better alleviate these issues, thereby achieving substantially higher mIoU scores. In the method, the pre-alignment version achieves better segmentation results than TTA. This is expected since in the pre-alignment version, the student network can distill the knowledge from a collection of shapes, instead of individual shape.

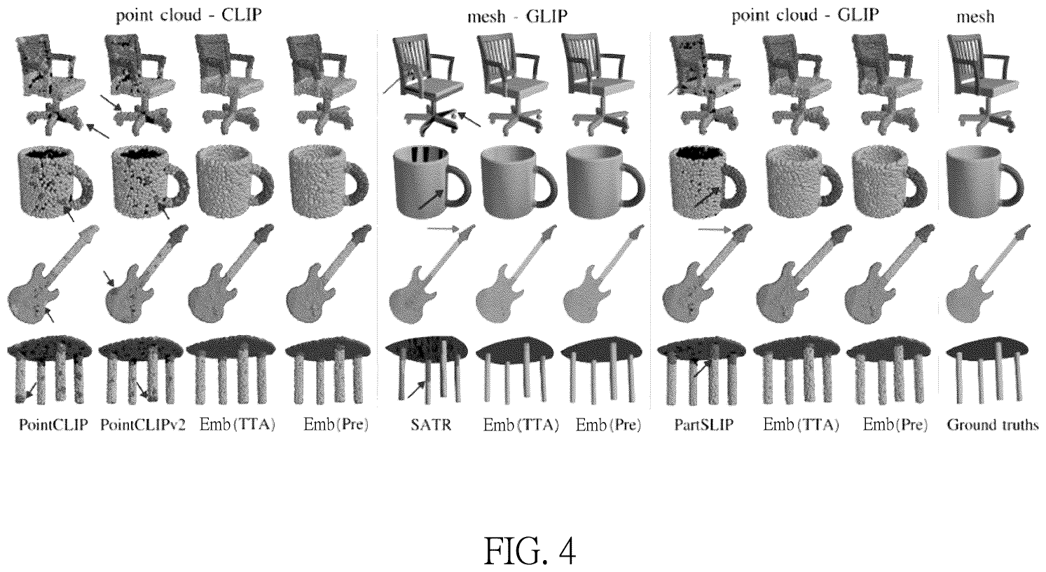

Besides foregoing quantitative comparisons, a qualitative comparison of the segmentation results is presented in FIG. 4. It is readily observed that all the competing methods suffer from the lack of 3D segmentation for the uncovered regions (issue I₁) caused by either occlusion or not being covered by any bounding box, drawn with black and gray colors, respectively. Moreover, these methods may also encounter negative transfers caused by inaccurate VLM outputs (issue I₂), such as those pointed by blue arrows, with notably degraded outcomes in SATR due to semantic leaking. Nonetheless, the method performs cross-modal distillation and alleviates these two issues, as can be seen in FIG. 4. In addition, due to a direct transfer of 2D predictions to 3D space which relies on each independent shape as in the competing methods, erroneous 2D predictions will just remain as incorrect 3D segmentation (issue I₃), such as the missed detected chair arms and guitar heads pointed by red arrows. The method also addresses this issue, by exploiting geometrical features across multiple shapes.

### 4.3. Few-Shot Segmentation

The effectiveness of the method is further demonstrated in a few-shot scenario by following the setting used in PartSLIP. Specifically, the fine-tuned GLIP model provided by PartSLIP is employed via 8-shot labeled shapes of the PartE dataset for each category. In addition to the alignment via Eq. 3, the student network is tasked to learn parameters that minimize both Eq. 3 and a standard crossentropy loss for segmentation on the 8 labeled shapes. Table 3 summarizes the corresponding few-shot segmentation results, with the PartSLIP and non-VLM-based methods' mIoUs taken from the reported mIoUs in the PartSLIP paper.

TABLE 3
Few-shot segmentation on the PartE dataset, reported in mIoU (%).

| Method | Bottle | Cart | Chair | Display | Kettle | Knife | Lamp | Oven | Suitcase | Table | Overall | Method |
|---|---|---|---|---|---|---|---|---|---|---|---|---|
| Non-VLM-based | PointNet++ | 27.0 | 11.6 | 42.2 | 30.2 | 28.6 | 22.2 | 10.5 | 19.4 | 3.3 | 7.3 | 20.4 |
| | PointNext | 67.6 | 47.7 | 65.1 | 53.7 | 60.6 | 59.7 | 55.4 | 36.8 | 14.5 | 22.1 | 40.6 |
| | ACD | 22.4 | 31.5 | 39.0 | 29.2 | 40.2 | 39.6 | 13.7 | 8.9 | 13.2 | 13.5 | 23.2 |
| | Prototype | 60.1 | 36.8 | 70.8 | 67.3 | 62.7 | 50.4 | 38.2 | 36.5 | 35.5 | 25.7 | 44.3 |
| VLM-based | PartSLIP | 83.4 | 88.1 | 85.3 | 84.8 | 77.0 | 65.2 | 60.0 | 73.5 | 70.4 | 42.4 | 59.4 |
| (GLIP) | Emb. | 84.6 | 90.1 | 88.4 | 87.4 | 78.6 | 71.4 | 69.2 | 72.8 | 73.4 | 63.3 | 65.9 |

As shown in Table 3, the methods dedicated to few-shot 3D segmentation, ACD and Prototype, are adapted to PointNet++ and PointNext backbones, respectively, and can improve the performances (on average) of these backbones. PartSLIP, on the other hand, leverages multi-view GLIP predictions for 3D segmentation and further improves the mIoU, but there are still substantial performance gaps compared to the method which distills the GLIP predictions instead. The results from fine-tuning Point-M2AE with the few-shot labels is also presented, which shows lower performances than the disclosed method, highlighting the significant contribution of the distillation framework. For more qualitative results, see the supplementary materials.

### 4.4. Leveraging Generated Data

TABLE 4
Segmentation mIoU (%) by leveraging generated data.

| | ShapeNetPart | | | COSEG | |
|---|---|---|---|---|---|
| Distilled data | Airplane | Chair | Guitar | Chair | Guitar |
| Train-set (baseline) | 69.3 | 86.2 | 76.8 | 96.4 | 68.0 |
| Gen. data | 69.0 | 85.3 | 75.6 | 96.1 | 67.5 |
| Gen. data & train-set | 70.8 | 88.4 | 78.3 | 97.4 | 70.2 |

Since only unlabeled 3D shape data are required for the method to perform cross-modal distillation, existing generative models can facilitate an effortless generation of 3D shapes, and the generated data can be smoothly incorporated into the method. Specifically, DiT-3D, which is pre-trained on the ShapeNet55 dataset, is first adopted to generate point clouds of shapes, 500 shapes for each category. SAP is then employed to transform the generated point clouds into mesh shapes. These generated mesh shapes can then be utilized in the method for distillation. Table 4 shows the results evaluated on the test-set data of ShapeNetPart and COSEG datasets for several shape categories, using GLIP as the VLM.

One can see that with distilling from the generated alone, the method already achieves competitive results on the ShapeNetPart dataset compared to distilling from the trainset data. Since the generated data via DiT-3D is pre-trained on the ShapeNet55 dataset which contains the ShapeNet-Part data, its performance is also evaluated on the COSEG dataset to demonstrate that such results can be well transferred to shapes from another dataset. Finally, Table 4 (the last row) reveals that using generated data as a supplementary knowledge source can further increase the mIoU performance. Such results suggest that if a collection of shapes is available, generated data can be employed as supplementary knowledge sources, which can improve the performance. On the other hand, if a collection of shapes does not exist, generative models can be employed for shape creation and subsequently used in the method as the knowledge source.

### 4.5. Ablation Studies

TABLE 5
Ablation study on the proposed method.

| | | | | Student | Airplane | | Chair | | Knife | |
|---|---|---|---|---|---|---|---|---|---|---|
| No | VLM | Pre | BD | network | 2D | 3D | 2D | 3D | 2D | 3D |
| (1) | GLIP | | | | 42.8 | 40.2 | 60.2 | 60.1 | 53.6 | 57.2 |
| (2) | | | | ✓ | 42.8 | 56.2 | 60.2 | 73.5 | 53.6 | 77.6 |
| (3) | | ✓ | | ✓ | 42.8 | 64.3 | 60.2 | 84.2 | 53.6 | 84.5 |
| (4) | | | ✓ | ✓ | 44.3 | 57.3 | 61.7 | 74.2 | 54.8 | 78.5 |
| (5) | | ✓ | ✓ | ✓ | 48.2 | 69.3 | 63.2 | 86.5 | 55.0 | 85.7 |
| (6) | | ✓ | ✓ | Exclude I₁ | 48.2 | 62.5 | 63.2 | 80.4 | 55.0 | 81.2 |
| (7) | | ✓ | ✓ | w/o pretrain | 48.2 | 69.1 | 63.2 | 86.7 | 55.0 | 85.3 |
| (8) | CLIP | ✓ | | ✓ | 34.6 | 38.4 | 50.4 | 63.6 | 66.8 | 77.4 |
| (9) | | ✓ | ✓ | ✓ | 37.8 | 40.6 | 54.2 | 65.0 | 68.4 | 78.9 |

Proposed components. Ablation studies are performed on the proposed components, and the mIoU scores in 2D and 3D spaces on three categories of the ShapeNetPart dataset are shown in (1) to (9) of Table 5. In (1), only GLIP box predictions are utilized to get 3D segmentations, i.e., part labels are assigned by voting from all visible points within the multi-view box predictions. These numbers serve as baselines and are subject to issues I₁-I₃. In (2) and (3), 3D segmentations are achieved via forward distillation from the GLIP predictions to the student network using Eq. 3, for test-time alignment (TTA) and pre-alignment (Pre) versions, resulting in significant improvements compared to the baselines, with more than 10% and 14% higher mIoUs, respectively. Such results demonstrate that the proposed cross-modal distillation can better utilize the 2D multi-view predictions for 3D part segmentation, alleviating I₁-I₃.

Backward distillation (BD) is added in (4) and (5), which substantially improves the knowledge source in 2D, e.g., from 42.8% to 48.2% for the airplane category in the pre-alignment version, and subsequently enhances the 3D segmentation. A higher impact (improvement) is observed on the pre-alignment compared to TTA versions, i.e., in (4) and (5), as the student network of the former can better integrate the knowledge from a collection of shapes. A similar trend of improvement can be observed for a similar ablation performed with CLIP used as the VLM (in (8) and (9)).

In (6), the method's predictions for those uncovered points are excluded to simulate issue I₁, and the reduced mIoUs compared to (5), e.g., from 86.5% to 80.4% for the chair category, reveal that the method can effectively alleviate issue I₁. Finally, instead of using pre-trained weights of Point-M2AE and freezing them as the 3D decoder as in (5), these weights are initialized (by default PyTorch initialization) and set to be learnable as in (7). Both settings produce comparable results (within 0.4%). The main purpose of using the pre-trained weights and freezing them is for faster convergence, especially for the test-time alignment purpose. Please refer to the supplementary material for the comparison of convergence curves.

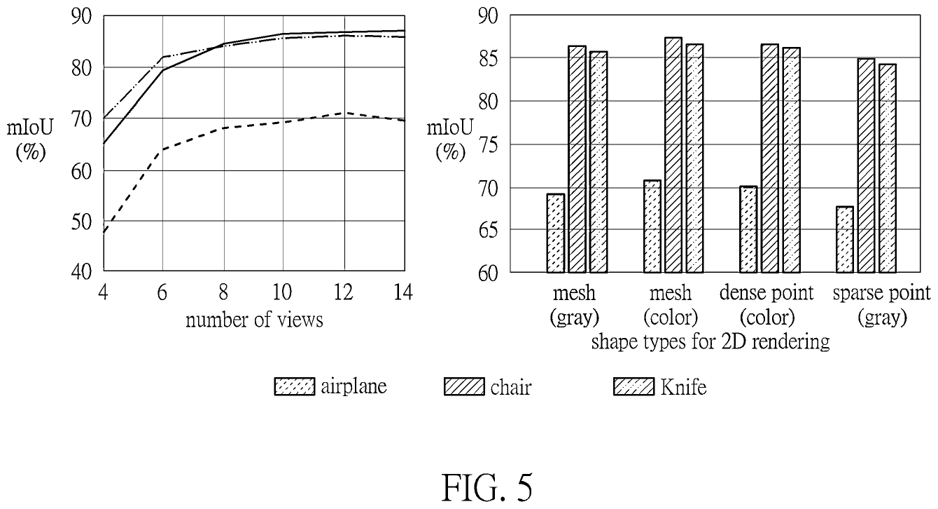

Number of views. V=10 multi-view images are rendered for each shape input in the main experiment, and FIG. 5 (left) shows the mIoU scores with different values of V. A substantial drop is observed when utilizing V<6, and small increases are obtained when a larger V is used.

Various shape types for 2D multi-view rendering. 10 multi-view images are rendered from various shape data types, i.c., (i) gray mesh, (ii) colored mesh, (iii) dense colored point cloud (˜300 k points) as used in PartSLIP, and (iv) sparse gray point cloud (2,048 points) using PyTroch3D and the rendering method to render (i)-(iii) and (iv), respectively. FIG. 5 (right) summarizes such results on the ShapeNetPart dataset, with GLIP used as the VLM. Note that the first three shape types produce comparable mIoUs with slightly higher scores when colored mesh or dense colored point cloud is utilized. When sparse gray point cloud data type is used, a mild mIoU decrease is observed. Please refer to the supplementary material to see more results for (i)-(iv).

Limitation. The main limitation of the method is that the segmentation results are impacted by the quality of the VLM predictions, where VLMs are generally pre-trained to recognize object-or sample-level categories (not part-level of object categories). For instance, GLIP can satisfactorily locate part semantics for the chair category but with lower qualities for the carphone category, while CLIP can favorably locate part semantics for the carphone category but with less favorable results for the airplane category. Hence, exploiting multiple VLMs can be a potential future work. Nonetheless, the proposed method which currently employs a single VLM model can already boost the segmentation results significantly compared to the existing methods.

### 5. Flow Sequence and Apparatus

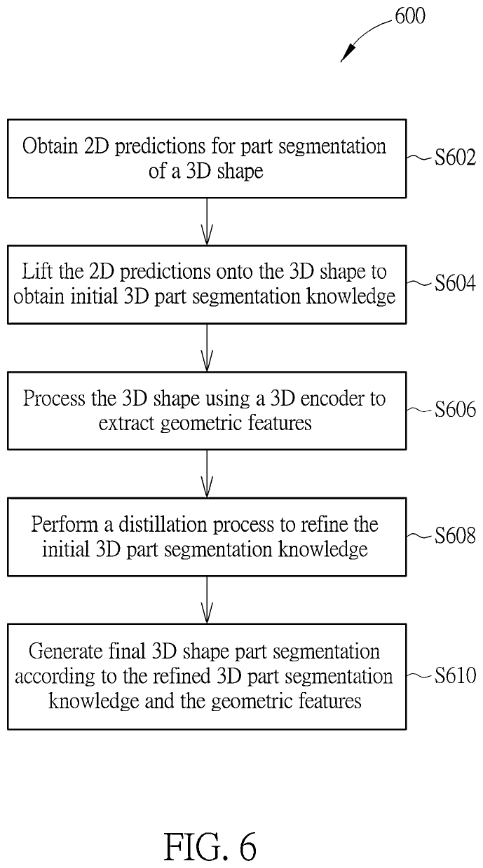

FIG. 6 depicts a flow diagram of a method 600 for 3D shape part segmentation according to the embodiments. The method 600 comprises the following steps:
S602: Obtain two-dimensional (2D) predictions for part segmentation of a 3D shape;
S604: Lift the 2D predictions onto the 3D shape to obtain initial 3D part segmentation knowledge;
S606: Process the 3D shape using a 3D encoder to extract geometric features;
S608: Perform a distillation process to refine the initial 3D part segmentation knowledge; and
S610: Generate final 3D shape part segmentation according to the refined 3D part segmentation knowledge and the geometric features.

The detailed procedures for implementing the method 600 are fully described in the specification above. For the sake of brevity, these procedures are not repeated in this portion of the document.

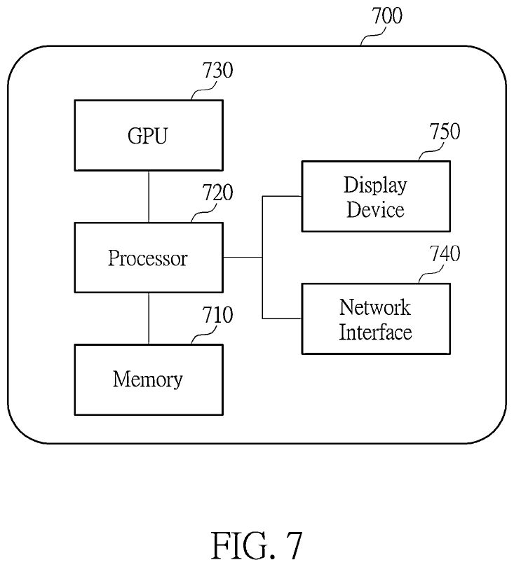

FIG. 7 depicts a simplified block diagram of an embodiment of an apparatus for performing the method for 3D shape part segmentation described above. The apparatus 700 for three-dimensional (3D) shape part segmentation comprises several interconnected components that work in concert to perform efficient and accurate segmentation tasks. A memory 710 stores both the executable instructions for the segmentation algorithm and the 3D shape data being processed. This memory 710 is closely coupled with a processor 720, which serves as the central computing unit of the apparatus 700.

The processor 720 directs the entire segmentation process, executing instructions stored in memory 710. It manages crucial functions such as rendering 2D images from the 3D shape, processing these images with a VLM, projecting 2D predictions back onto the 3D shape, encoding 3D geometric features, and performing both forward and backward knowledge distillation. The processor 720 ultimately generates the final 3D shape part segmentation by combining refined knowledge with extracted geometric features.

The processor 720 in apparatus 700 can be implemented using various types of central processing units (CPUs) depending on the required performance and power efficiency. For instance, it could be an x86-based processor or an ARM-based processor, for desktop, mobile or embedded systems. As for the memory 710, it typically comprise of fast, volatile RAM for active data processing, which could be DDR4 or DDR5 SDRAM with capacities ranging from 16 GB to 128 GB or more, depending on the complexity of the 3D shapes being processed. This might be complemented by non-volatile storage like a solid-state drive (SSD) with capacities of 512 GB to several terabytes, using NVMe technology for fast data access, to store the segmentation software, model weights, and a database of 3D shapes.

To accelerate graphical and parallel computing tasks, the apparatus 700 can incorporate a graphic processing unit (GPU) 730 coupled to the processor 720. The GPU 730 significantly enhances performance by speeding up the rendering of 2D images and the processing of 3D shapes, particularly during the 3D encoding step. This allows the apparatus 700 to handle complex 3D shapes efficiently, often achieving real-time or near-real-time segmentation.

The apparatus 700 can also feature a network interface 740, which facilitates data input and output. This interface 740 is capable of receiving 3D shape data in various formats and transmitting segmentation results, allowing the apparatus 700 to be integrated into larger systems or workflows. The network interface 740 can be implemented in various ways to accommodate different networking requirements. For example, it may include a standard Gigabit Ethernet port for high-speed wired connections, a Wi-Fi module for wireless network access, or a 5G modem for mobile connectivity. In scenarios requiring extremely high bandwidth, such as processing large volumes of high-resolution 3D scans, the network interface 740 might feature a fiber optic port. For short-range communication or connecting to external devices, it could incorporate Bluetooth or USB ports. This versatility in the network interface 740 allows the apparatus 700 to adapt to various environments and use cases. For instance, in a medical imaging facility, it might use an Ethernet or fiber optic connection to receive large 3D scans directly from imaging equipment, while in a mobile robotics application, the 5G or Wi-Fi capability could enable real-time processing of 3D data as a robot explores an environment. The flexibility of the network interface 740 thus extends the utility of the apparatus 700 across a wide range of 3D shape segmentation scenarios.

Finally, a display device 750 is included to visualize the final 3D shape part segmentation, providing a crucial interface for users to interpret and validate the results. The display device 750 can show, for example, the original 3D shape, the segmented 3D shape with different parts highlighted, individual segmented parts in isolation, and intermediate results from the segmentation process for debugging or analysis. The display device 750 can be implemented using various technologies to suit different visualization needs. For instance, it might feature a high-resolution LCD or OLED monitor capable of displaying detailed 3D renderings with accurate color reproduction. For more immersive visualization, the display device 750 could incorporate a virtual reality (VR) headset, allowing users to examine segmented 3D shapes in a fully three-dimensional space. Alternatively, it might include a large-format touchscreen display, enabling interactive manipulation of 3D models and segmentation results. For collaborative work environments, the display device 750 could be a high-definition projector system, capable of presenting 3D segmentations on a large screen for group analysis. In portable applications, it might be a compact, high-brightness display with wide viewing angles. Some implementations might even feature holographic displays for truly spatial 3D visualization. The choice of display technology would depend on factors such as the level of detail required, the need for interactivity, the working environment, and the number of simultaneous viewers.

In operation, these components of apparatus 700 work together seamlessly. The processor 720 coordinates the flow of data and computation, utilizing the GPU 730 for intensive tasks. The memory 710 provides fast access to instructions and data, while the network interface 740 allows for flexible input and output. The display device 750 offers immediate visual feedback, enhancing the usability of the apparatus 700 for both automated processing and interactive use scenarios.

### 6. Conclusion

A cross-modal distillation framework that transfers 2D knowledge from a vision-language model (VLM) to facilitate 3D shape part segmentation is presented, which generalizes well to both VLM with bounding-box and pixel-wise predictions. In this method, backward distillation is introduced to enhance the quality of 2D predictions and subsequently improve the 3D segmentation. The approach can also leverage existing generative models for shape creation and can be smoothly incorporated into the method for distillation. With extensive experiments, the proposed method is compared with existing methods on widely used benchmark datasets, including ShapeNetPart and PartNetE, and consistently outperforms existing methods with substantial margins both in zero-shot and few-shot scenarios on 3D data in point clouds or mesh shapes.

Building upon the core strengths of PartDistill, this method offers several additional advantages that position it as a significant advancement in 3D shape understanding. The framework's flexibility is a key asset, demonstrating remarkable versatility in working with both bounding box and pixel-wise VLM predictions. This adaptability allows PartDistill to leverage a wide range of pre-trained vision-language models, making it suitable for diverse application scenarios and enabling researchers and practitioners to utilize the most appropriate models for their specific tasks.

A notable feature of PartDistill is its ability to seamlessly incorporate gencrated 3D shapes from existing generative models as additional knowledge sources. This capability not only enhances the robustness of the segmentation process but also potentially reduces the reliance on large, manually annotated datasets. By tapping into the power of generative models, PartDistill can augment its training data, leading to more comprehensive and accurate segmentation results across a broader range of shape variations.

The efficient knowledge transfer mechanism employed by PartDistill is another significant advantage. By distilling knowledge from 2D to 3D, this method effectively bridges the gap between these modalities, allowing 3D segmentation to benefit from the rich semantic understanding of pre-trained 2D models. This approach circumvents the need for extensive 3D training data, which is often scarce and expensive to obtain. Furthermore, the scalability of PartDistill is evident in its strong performance across different shape categories and complexities, indicating its potential for handling even larger and more diverse 3D datasets in the future.

From a technical perspective, PartDistill offers enhanced interpretability through its bi-directional distillation process. This provides valuable insights into how knowledge is transferred between 2D and 3D domains, potentially opening new avenues for understanding and improving cross-modal learning in computer vision. The method also promotes resource efficiency by leveraging pre-trained 2D models, reducing the need to train large 3D models from scratch. This approach could lead to more cost-effective and environmentally friendly 3D understanding systems.

Lastly, the strong performance of PartDistill in zero-shot and few-shot scenarios makes it particularly promising for real-world applications where annotated 3D data is scarce or expensive to obtain. Fields such as medical imaging, robotics, and augmented reality could greatly benefit from this capability, enabling more rapid deployment of 3D segmentation technologies in practical settings. As researchers look to the future, PartDistill opens up exciting possibilities for extending this approach to more complex 3D tasks, incorporating temporal information for 4D analysis, or adapting the method for real-time 3D segmentation in dynamic environments.

### 7. Additional Notes

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any conventional processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for three-dimensional (3D) shape part segmentation, performed by a processor, comprising:
obtaining two-dimensional (2D) predictions for part segmentation of a 3D shape;
lifting the 2D predictions onto the 3D shape to obtain initial 3D part segmentation knowledge;
processing the 3D shape using a 3D encoder to extract geometric features;
performing a distillation process to refine the initial 3D part segmentation knowledge; and
generating a final 3D shape part segmentation according to the refined 3D part segmentation knowledge and the geometric features.

2. The method of claim 1, wherein obtaining the 2D predictions comprises:
rendering a plurality of 2D images from a plurality of views of the 3D shape; and
processing the plurality of 2D images using the vision-language model (VLM) to obtain the 2D predictions for part segmentation.

3. The method of claim 2, wherein the VLM generates bounding box predictions and/or pixel-wise predictions.

4. The method of claim 1, wherein the distillation process comprises:
performing forward distillation by aligning output of the distillation head with the lifted initial 3D part segmentation knowledge; and
performing backward distillation to refine the lifted initial 3D part segmentation knowledge based on the aligned output of the distillation head.

5. The method of claim 4, wherein the distillation head comprises the geometric features.

6. The method of claim 4, wherein performing backward distillation comprises re-scoring confidence values associated with the lifted initial 3D part segmentation knowledge according to agreement between the initial knowledge and the aligned output of the distillation head.

7. The method of claim 4, wherein performing forward distillation comprises minimizing a masked cross-entropy loss between the output of the distillation head and the lifted initial 3D part segmentation knowledge.

8. The method of claim 1, wherein lifting the 2D predictions onto the 3D shape comprises performing back-projection of the 2D predictions using camera parameters associated with the rendering of the 2D images.

9. The method of claim 1, further comprising generating a mask indicating which points of the 3D shape are covered by the 2D predictions.

10. The method of claim 1, wherein data of the 3D shape is stored in a memory.

11. An apparatus for three-dimensional (3D) shape part segmentation, comprising:
a memory configured to store instructions and 3D shape data; and
a processor coupled to the memory, configured to execute the instructions to:
obtain two-dimensional (2D) predictions for part segmentation of a 3D shape;
lift the 2D predictions onto the 3D shape to obtain initial 3D part segmentation knowledge;
process the 3D shape using a 3D encoder to extract geometric features;
perform a distillation process to refine the initial 3D part segmentation knowledge; and
generate a final 3D shape part segmentation according to the refined 3D part segmentation knowledge and the geometric features.

12. The apparatus of claim 11, further comprising:
a graphics processing unit (GPU) coupled to the processor, configured to accelerate rendering of the 2D images and processing of the 3D shape;
a network interface coupled to the processor, configured to receive 3D shape data and transmit segmentation results; and
a display device coupled to the processor, configured to display the final 3D shape part segmentation.

13. The apparatus of claim 11, wherein the 2D predictions is obtained by:
rendering a plurality of 2D images from a plurality of views of the 3D shape; and
processing the plurality of 2D images using the vision-language model (VLM) to obtain the 2D predictions for part segmentation.

14. The apparatus of claim 13, wherein the VLM generates bounding box predictions and/or pixel-wise predictions.

15. The apparatus of claim 11, wherein the distillation process comprises:
performing forward distillation by aligning output of the distillation head with the lifted initial 3D part segmentation knowledge; and
performing backward distillation to refine the lifted initial 3D part segmentation knowledge based on the aligned output of the distillation head.

16. The apparatus of claim 15, wherein the distillation head comprises the geometric features.

17. The apparatus of claim 15, wherein forward distillation is performed by minimizing a masked cross-entropy loss between the output of the distillation head and the lifted initial 3D part segmentation knowledge.

18. The apparatus of claim 15, wherein backward distillation is performed by re-scoring confidence values associated with the lifted initial 3D part segmentation knowledge according to agreement between the initial knowledge and the aligned output of the distillation head.

19. The apparatus of claim 11, wherein projecting the 2D predictions onto the 3D shape is performed with back-projection of the 2D predictions using camera parameters associated with the rendering of the 2D images.

20. The apparatus of claim 11, wherein the processor is further configured to execute the instructions to generate a mask indicating which points of the 3D shape are covered by the 2D predictions.
